(19) United States
(12) Patent Application Publication
(10) Pub. No.: US 2006/0027576 A1
(43) Pub. Date: Feb. 9, 2006

(54) Fuel cartridge and fuel cell system

(76) Inventor: Mitsuo Yokozawa, Nagano (JP)

Correspondence Address: CANTOR COLBURN, LLP, 55 GRIFFIN ROAD SOUTH, BLOOMFIELD, CT, 06002, US

(21) Appl. No.: 11/190,338

(22) Filed: Jul. 27, 2005

(30) Foreign Application Priority Data
Aug. 3, 2004 (JP) 2004-226887

(51) Int. Cl. B65D 6/00; H01M 8/04

(52) U.S. Cl. 220/4.12; 429/34

(57) ABSTRACT

A fuel cartridge for a power generating device of a fuel cell system includes a main body container formed of a rigid body, a flexible bag shaped container into which the fuel is to be stored and which is disposed inside of the main body container such that they are constructed in a double structure, and a collection tank which is formed by a space between an inner side of the main body container and an outer side of the bag shaped container for collecting a product generated in the power generating device. The fuel cartridge constructs a fuel cell system together with a power generating device including a power generating part, and a pump disposed between the fuel cartridge and the power generating device.

### CROSS REFERENCE TO RELATED APPLICATION

The present invention claims priority under 35 U.S.C. §119 to Japanese Application No. 2004-226887 filed Aug. 3, 2004, which is incorporated herein by reference.

### FIELD OF THE INVENTION

The present invention relates to a direct methanol type of fuel cell system and a fuel cartridge used in the fuel cell system.

### BACKGROUND OF THE INVENTION

Expectation for a fuel cell has been elevated as a power supply for a portable electronic device used in an information society in recent years or as a power supply for coping with air pollution or global warming. Among the fuel cells, a direct methanol type of fuel cell (hereinafter, referred as DMFC: Direct Methanol Fuel Cell) in which power generation is performed by directly taking out protons from methanol provides characteristics that a reformer is not required and the volume energy density is high, and thus application to a portable electronic device has been increasingly expected.

A fuel cell system is commonly provided with a power generating device having a power generating part (cell). The cell is constructed so as to include an anode electrode (fuel electrode) having an anode collector and an anode catalyst layer, a cathode electrode (air electrode) having a cathode collector and a cathode catalyst layer, and an electrolyte membrane disposed between the anode electrode and the cathode electrode.

A conventional fuel cell system is provided with a fuel cartridge stored with 100% methanol as a fuel and a vessel for methanol aqueous solution in which the 100% methanol is diluted with water. Further, a so-called active type of fuel cell system has been known which is provided with a plurality of auxiliary devices such as a liquid feed pump for supplying methanol aqueous solution to the anode electrode and an air supply pump for supplying air to the cathode electrode (see, for example, Japanese Patent Laid-Open No. 2004-152741).

A so-called passive type of fuel cell system has been proposed in which methanol aqueous solution and air are supplied to the anode electrode and the cathode electrode by utilizing natural convection or a capillary phenomenon without providing the auxiliary devices such as a liquid feed pump or an air supply pump (see, for example, Japanese Patent Laid-Open No. 2000-268835). The fuel cell system described in Japanese Patent Laid-Open No. 2000-268835 is provided with a fuel cartridge in which methanol aqueous solution diluted beforehand is stored.

In the fuel cell system, the methanol aqueous solution which is supplied reacts in accordance with the following equation (1) in the anode electrode to dissociate into a carbon dioxide, hydrogen ions and electrons.
CH₃ OH+H₂O→ CO₂+6H⁺+6e⁻ (1)
The hydrogen ions that are generated move through the electrolyte membrane from the anode electrode to the cathode electrode. In the cathode electrode, the hydrogen ions and oxygen in the air react in accordance with the following equation (2) to generate water.
3/2O₂+6H⁺+6e⁻→3 H₂O (2)

In this manner, the fuel cell system requires the disposal of generated water which is generated by power generation at a molecule ratio of three with respect to one methanol. Further, harmful matters such as various methanol partial oxides, for example, formaldehyde or formic acid, or carbon monoxide may be generated in the process that the methanol molecule and the water molecule are resolved in the anode electrode. In addition, since one part of the methanol molecules supplied to the anode electrode may permeate (crossover) through the electrolyte membrane without reaction, partial oxides such as formaldehyde or formic acid may be also generated in the process of oxidization in the cathode electrode. However, in the fuel cell system described in the above-mentioned prior arts, a satisfactory disposal method for the generated water has not been proposed. As a method for processing the generated water, methods are conceived in which excessive generated water is diffused naturally in the air or excessive generated water is collected into a collecting tank provided separately from the fuel cartridge.

However, in the former method described above, when ambient humidity in the fuel cell system is high, the generated water which is excessive cannot be sufficiently diffused in the air, and thus dew condensation may be formed in the vicinity of an outlet opening provided for naturally diffusing the generated water and mildew may grow. On the other hand, in the latter method described above, a collection tank is required, and thus the fuel cell system is enlarged and its volume efficiency is reduced and, in addition, a pump for collecting the generated water is required. In addition, maintenance operation for the collection tank is also required as well as the exchanging work of the fuel cartridge.

Further, in the fuel cartridge for the fuel cell system described in the above-mentioned prior art, air is required to be taken into the fuel cartridge from outside by an amount that corresponds to the volume of the supplied methanol or the methanol aqueous solution so that the pressure of the inside of the cartridge does not become negative. Therefore, the inside of the fuel cartridge is in a coexisting state of liquid and gas (air). Accordingly, when air exists in the outflow port of the fuel cartridge based on the attitude of the fuel cell system, the fuel cannot be supplied by natural convection and further, the fuel may not be appropriately supplied even when a liquid feed pump is used. In other words, the fuel cell system provided with the fuel cartridge within which liquid and gas (air) are coexisted is not suitable for a device such as a portable electronic device whose attitude is changed.

In addition, the so-called active type of fuel cell system described above includes a plurality of auxiliary devices. Therefore, the plurality of auxiliary devices consume electric power which is generated in the power generating device and thus the power generation efficiency in the entire fuel cell system is low.

On the other hand, since the so-called passive type of fuel cell system utilizes natural convection or a capillary phenomenon, the amounts of the methanol aqueous solution and air are varied which are supplied to the anode electrode or the cathode electrode. Therefore, the chemical reaction in the anode electrode or the cathode electrode may not be efficiently performed. Further, the chemical reaction cannot be stopped forcibly. Therefore, the methanol which is a fuel is consumed even when the power generation is unnecessary. Accordingly, the power generation efficiency is low even in the passive type of fuel cell system.

### SUMMARY OF THE INVENTION

In view of the problems described above, the present invention may advantageously provide a fuel cartridge which is provided with a sufficient disposal function of the generated water that is generated in the power generating part and which is capable of improving the volume efficiency of a fuel cell system. Further, the present invention may advantageously provide a fuel cell system provided with the fuel cartridge. Further, the present invention may advantageously provide a fuel cartridge which is capable of supplying fuel regardless of the attitude of the fuel cartridge, and a fuel cell system provided with the fuel cartridge.

Further, the present invention may advantageously provide a fuel cell system which is provided with a structure capable of improving the power generation efficiency.

Thus, according to the present invention, there may be provided a fuel cartridge which stores fuel to be supplied to the power generating device of a fuel cell system including a main body container formed of a rigid body, a bag shaped container having flexibility which is disposed inside of the main body container such that the main body container and the bag shaped container are constructed in a double structure, the fuel being stored in the bag shaped container, and a collection tank which is formed by a space between the inner side of the main body container and the outer side of the bag shaped container for collecting a product generated in the power generating device.

The fuel cartridge in an embodiment of the present invention is constructed in a double structure which includes a main body container formed of a rigid body and a bag shaped container having flexibility which is disposed inside of the main body container and into which the fuel is stored. Further, a space between the inner side of the main body container and the outer side of the bag shaped container is utilized as a collection tank for collecting products generated in the power generating device. In other words, for example, the space of the inside of the main body container generated by the reduction of the methanol aqueous solution as fuel may be utilized as the collection tank for collecting the generated water as the product. Therefore, the collection tank is not required to be provided separately and the volume efficiency of the fuel cell system can be improved.

Further, fuel is stored in the bag shaped container and the bag shaped container has a flexible property. Therefore, when a pressure is applied to the bag shaped container from the outside, or when the fuel is sucked from the bag shaped container, the fuel can be supplied from the fuel cartridge regardless of the attitude of the fuel cartridge.

Further, the collection tank for the product is formed in the inside of the main body container of the fuel cartridge. Therefore, the collection tank is automatically exchanged when the fuel cartridge is exchanged after the fuel has been used up. Accordingly, the maintenance operation which is dedicated to the collection tank is not required and thus maintenance operation of the fuel cell system becomes easy.

In the specification of the present invention, the “main body container formed of a rigid body” may mean a container whose volumetric capacity and shape is hardly changed by the differential pressure between the pressure of the inside of the main body container and the pressure of the outside of the main body container. Further, the “bag shaped container having flexibility” may mean a bag-shaped container whose shape can be flexibly changed according to the change of the capacity of the content that is stored in the container. Further, the “fuel is stored in the bag shaped container” may mean both the case that only fuel is stored in the inside of the bag shaped container and the case that fuel and a very small amount of gas such as air or the like which can be ignored are mixed. The “product” means, for example, the generated water or a by-product such as formaldehyde, formic acid and carbon monoxide.

In accordance with an embodiment of the present invention, a filter for adsorbing at least a part of the product is preferably disposed in the inside of the main body container. In this case, harmful matters such as formaldehyde, formic acid, carbon monoxide or the like which are generated in the power generating device can be adsorbed by the filter. Therefore, even when exhaust-gas collected from the power generating device is discharged from the collection tank to the outside, harmful matters are not discharged and thus a clean fuel cell system can be provided. Further, when the filter for adsorbing generated water that is generated in the power generating device is disposed, moisture is adsorbed by the filter and thus the possibility is remarkably reduced that dew condensation and mildew are generated in the vicinity of the discharge port of exhaust-gas when the exhaust-gas from the power generating device is discharged to the outside.

Further, according to an embodiment of the present invention, there may be provided a fuel cell system including the above-mentioned fuel cartridge, a power generating device including a power generating part, and a pump disposed between the fuel cartridge and the power generating device. In the fuel cell system, wherein an inflow port of the pump is connected to a cathode electrode constructing the power generating part, whereby the suction of the pump supplies oxygen to the cathode electrode and collects air and water to the collection tank, the water being generated in the cathode electrode, and an outflow port of the pump is connected to the collection tank and increases the pressure of the main body container.

In the fuel cell system in accordance with an embodiment of the present invention, since the inflow port of the pump is connected to the cathode electrode, oxygen is supplied to the cathode electrode when the pump sucks generated water which is generated in the cathode electrode and air in the cathode electrode. Further, the outflow port of the pump is connected to the collection tank and the generated water is collected in the collection tank. Therefore, only one pump is provided with a collecting function of the generated water generated in the cathode electrode and a supply function of oxygen to the cathode electrode. Accordingly, the downsizing of a fuel cell system can be attained and its volume efficiency can be improved in comparison with the case wherein two pumps having individual functions are provided. Further, since the number of pumps decreases, electric power consumed in the auxiliary device can be reduced and, as a result, power generation efficiency can be improved.

In accordance with an embodiment of the present invention, the internal pressure of the main body container is preferably increased by the pump. In this case, since the internal pressure of main body container is increased by the pump, a pressure can be applied to the bag shaped container which is disposed in the inside of the main body container and thereby fuel can be supplied to the anode electrode. Therefore, the fuel supply function to the anode electrode can be further added to the one pump. Accordingly, further downsizing of the fuel cell system can be attained and its volume efficiency can be improved. Further, the electric power consumed in the auxiliary device can be reduced and, as a result, power generation efficiency can be improved. Moreover, since the fuel is supplied to the anode electrode by applying a pressure to the bag shaped container from the outside, the fuel can be supplied even when the fuel cell system is set in any attitude.

Further, according to an embodiment of the present invention, there may be provided a fuel cell system including the above-mentioned fuel cartridge, a power generating device including a power generating part, and a pump disposed between the fuel cartridge and the power generating device. In the fuel cell system, the inflow port of the pump is connected to a cathode electrode constructing the power generating part, the outflow port of the pump is connected to the collection tank, and the pump supplies oxygen to the cathode electrode and increases an internal pressure of the main body container by means of that the pump sucks the generated water that is generated in the cathode electrode and air in the cathode electrode.

In accordance with an embodiment of the present invention, the inflow port of the pump is connected to the cathode electrode and the pump supplies oxygen to the cathode electrode by means of that the pump sucks the generated water that is generated in the cathode electrode and air in the cathode electrode. Further, the outflow port of the pump is connected to the collection tank to increase the internal pressure of the main body container, and thus a pressure can be applied to the bag shaped container which is disposed in the inside of the main body container and thereby fuel can be supplied to the anode electrode. Therefore, only one pump is provided with two functions and thus the downsizing of the fuel cell system can be attained and its volume efficiency can be improved. Further, the electric power consumed in the auxiliary device can be reduced and, as a result, power generation efficiency can be improved. Moreover, since the fuel is supplied to the anode electrode by applying a pressure to the bag shaped container from the outside, the fuel can be supplied even when the fuel cell system is set in any attitude.

Further, according to an embodiment of the present invention, there may be provided a fuel cell system including the above-mentioned fuel cartridge, a power generating device including a power generating part, and a pump disposed between the fuel cartridge and the power generating device. In the fuel cell system, the inflow port of the pump is connected to a cathode electrode constructing the power generating part, the outflow port of the pump is connected to the collection tank, and the pump collects generated water which is generated in the cathode electrode to the collection tank and increases an internal pressure of the main body container.

In accordance with an embodiment of the present invention, the inflow port of the pump is connected to the cathode electrode, the outflow port of the pump is connected to the collection tank and the generated water is collected to the collection tank. Further, since the internal pressure of the main body container is increased by the pump, a pressure can be applied to the bag shaped container which is disposed in the inside of the main body container and thereby fuel can be supplied to the anode electrode. Therefore, only one pump is provided with two functions and thus the downsizing of the fuel cell system can be attained and its volume efficiency can be improved. Further, the electric power consumed in the auxiliary device can be reduced and, as a result, power generation efficiency can be improved. Moreover, since the fuel is supplied to the anode electrode by applying a pressure to the bag shaped container from the outside, the fuel can be supplied even when the fuel cell system is set in any attitude.

In accordance with an embodiment of the present invention, the bag shaped container is preferably connected to an anode electrode constructing the power generating part through a valve whose opening and closing are controllable. In this case, when the valve is closed, the outflow of the fuel from the bag shaped container is prevented and, only when power generation is required, the fuel can be supplied to the anode electrode, and thus power generation efficiency can be improved. Further, for example, even when the fuel cell system is used in a portable device, the possibility becomes remarkably low that the fuel flows out due to vibrations and impacts at the time of carrying the portable device and thus the fuel can be effectively utilized.

In accordance with an embodiment of the present invention, the fuel cell system is preferably provided with a pressure regulation mechanism which maintains one of a differential pressure between the internal pressure of the main body container and the pressure of an outlet port of the anode electrode and a differential pressure between the internal pressure of the main body container and the external-pressure of the main body container at a predetermined pressure. In this case, the differential pressure between the internal pressure of the main body container and the pressure of the outlet port of the anode electrode can be maintained at the predetermined pressure. Therefore, the supply amount of the fuel which is supplied to the anode electrode can be controlled by the opening and closing of the valve. Further, when the differential pressure between the internal pressure of the main body container and the external-pressure is maintained at the predetermined pressure, the differential pressure between the internal pressure of the main body container and the pressure of the outlet port of the anode electrode can be indirectly maintained at the predetermined pressure.

In accordance with an embodiment of the present invention, the power generating device may be provided with a plurality of power generating parts and a plurality of valves are provided so as to correspond to a plurality of anode electrodes of the plurality of power generating parts. In this case, the discharge destination of the fuel can be controlled even when a plurality of power generating parts are provided. In addition, even in the case that clogging occurs at the supply passage of the fuel to one of the anode electrodes, the fuel can be discharged to the supply passage where the clogging occurs. Therefore, the clogging may be eliminated and the supply of the fuel can be stabilized.

In accordance with an embodiment of the present invention, the inflow port of the pump is preferably connected to an anode electrode constructing the power generating part. In this case, carbon dioxide or the like generated in the anode electrode can be sucked by the pump and a negative pressure is generated in the anode electrode, and thus the fuel can be efficiently supplied to the anode electrode. As a result, the power generation efficiency can be improved.

As described above, in the fuel cartridge in accordance with an embodiment of the present invention, the space between the inner side of the main body container and the bag shaped container generated by the reduction of the fuel may be utilized as the collection tank for collecting the generated product. Therefore, even when the collection tank is not provided separately, the generated water, for example, which is generated in the cathode electrode can be sufficiently disposed. Moreover, since the collection tank is not required to be provided separately, the volume efficiency of the fuel cell system can be improved.

Further, fuel is stored in the bag shaped container having a flexible property and gas such as air or the like may be present only in a negligible extent in the bag shaped container. Therefore, when a pressure is applied to the bag shaped container from the outside, or when the fuel is sucked from the bag shaped container, the fuel can be supplied from the fuel cartridge regardless of the attitude of the fuel cartridge.

In addition, in the fuel cell system in accordance with an embodiment of the present invention, only one pump is provided with at least two functions among the collecting function of the generated water generated in the cathode electrode, the supply function of oxygen to the cathode electrode and the fuel supply function to the anode electrode. Therefore, downsizing of the fuel cell system can be attained and its volume efficiency can be improved. Further, since the number of pumps decreases, the electric power consumed in the auxiliary device can be reduced and, as a result, power generation efficiency can be improved.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

Embodiments will now be described, by way of example only, with reference to the accompanying drawing which is meant to be exemplary, not limiting, in which:

FIG. 1 is a schematic view showing the basic structure of a fuel cell system in accordance with an embodiment of the present invention.

### DETAILED DESCRIPTION OF THE PREFERRED EMBODIMENTS

Several embodiments of the present invention will be described below with reference to the accompanying drawing.

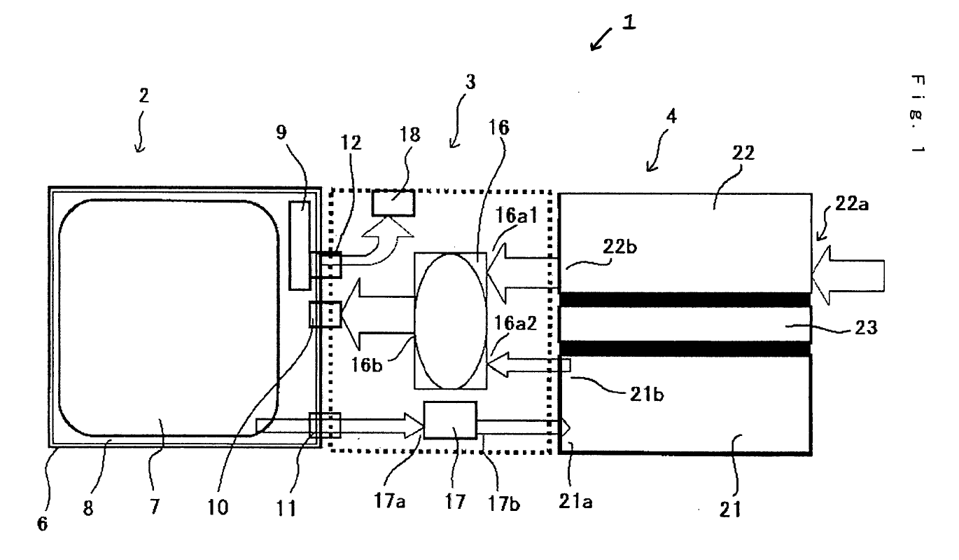

FIG. 1 is a schematic view showing the basic structure of a fuel cell system in accordance with an embodiment of the present invention.

A fuel cell system 1 in accordance with an embodiment of the present invention uses a DMFC and is used, for example, in a portable electronic device. In FIG. 1, the fuel cell system 1 includes a fuel cartridge 2 within which fuel is stored, a power generating device 4 having a power generating part (cell), and an auxiliary device 3 that is disposed between the fuel cartridge 2 and the power generating device 4. Fuel in an embodiment of the present invention is, for example, methanol aqueous solution of 64 wt.%.

The power generating part of the power generating device 4 is structured to include an anode electrode 21 having an anode collector and an anode catalyst layer, a cathode electrode 22 having a cathode collector and a cathode catalyst layer, and an electrolyte membrane 23 disposed between the anode electrode 21 and the cathode electrode 22.

The anode electrode 21 is provided with a supply port 21a for methanol aqueous solution and an outlet port 21b from which CO₂ or the like is discharged which is generated by chemical reaction in the anode electrode 21. The cathode electrode 22 is provided with a supply port 22a for air and an outlet port 22b from which water generated by chemical reaction in the cathode electrode 22 is discharged or air and the like within the cathode electrode 22 is discharged.

The fuel cartridge 2 is constructed in a double structure which is provided with a main body container 6 and a bag shaped container 7 disposed in the inside of the main body container 6. A portion between the inner side of the main body container 6 and the outer side of the bag shaped container 7 is formed to be a collection tank 8 for collecting a product generated in the power generating device 4. A filter 9 for adsorbing at least one part of the generated product is disposed in the inside of the main body container 6. In an embodiment of the present invention, the product includes generated water and carbon dioxide, which are normally generated in the power generating device 4, and by-products such as formic acid, formaldehyde, and carbon monoxide which are generated in the reaction process and collected without performing further reaction.

The main body container 6 is formed of resin material having a high rigidity such as poly ethylene terephthalate (PET) such that its volumetric capacity and shape is hardly changed by the differential pressure between the internal pressure of the main body container 6 and the external-pressure (atmospheric pressure). The main body container 6 is provided with an inflow port 10, through which a product and air discharged from the power generating device 4 flow in, an outflow port 11, through which methanol aqueous solution is flowed to the anode electrode 21, and an exhaust port 12 through which gas in the inside of the main body container 6 is exhausted. The inflow port 10 and the exhaust port 12 are in communication with the collection tank 8 and the outflow port 11 is in communication with the bag shaped container 7. The main body container 6 is formed in a rectangular solid shape, for example, of 50 mm×30 mm×150 mm.

The bag shaped container 7 is a flexible container whose shape can be flexibly changed according to the change of the volume of the content which is stored in the bag shaped container 7. For example, the bag shaped container 7 is formed by using a laminated film in which polypropylene, aluminum and nylon are laminated like a bag-shaped container that is used for pouch-packed food. Methanol aqueous solution is stored in the bag shaped container 7 and thus the bag shaped container 7 is a fuel tank. The bag shaped container 7 and the outflow port 11 are connected by an outflow passage for the methanol aqueous solution. In an embodiment of the present invention, the maximum volumetric capacity of the bag shaped container 7 is set to be, for example, 200 mL.

The collection tank 8 which is formed between the inner side of the main body container 6 and the outer side of the bag shaped container 7 accommodates principally generated water which is generated in the cathode electrode 22. Most of the generated water which is generated in the cathode electrode 22 becomes steam to be sent into the collection tank 8. However, since the temperatures of the inner wall of the collection tank 8 and the surface of the main body container 6 are lower than that of the cathode electrode 22, a part of the steam condenses to be water drops and collected in the collection tank 8.

The molecular weight of methanol is 32 and the molecular weight of water is 18. Therefore, for example, methanol aqueous solution comprised of two mols of methanol and two mols of water becomes a 64 wt. % mixed solution of 100 g and its volume is about 116 cc. When the 64 wt. % methanol aqueous solution of 100 g is entirely changed into water in the power generating part by the above-mentioned equations (1) and (2), six mols of water is generated and the mass of the generated water is 108 g and its volume becomes 108 cc. In other words, the methanol aqueous solution of 116cc is supplied from the bag shaped container 7 which is a fuel tank and the generated water up to 108 cc is collected in the collection tank 8. Accordingly, since the generated water that is collected in collection tank 8 takes less volume than the methanol aqueous solution supplied from the bag shaped container 7, the generated water generated in the cathode electrode 22 can be sufficiently collected in the fuel cartridge 2.

The filter 9 includes a water absorption sheet made of high polymer water absorbing property resin, a harmful matter absorption sheet for adsorbing harmful matters such as formaldehyde, and a water separator disposed around these sheets for which, for example, Gore-Tex (registered trademark) is used. Drops of water among the collected products cannot transmit through the water separator and stays in the collection tank 8. Gas in the inside of the main body container 6 is capable of being exhausted from the exhaust port 12 through the filter 9. More concretely, among the generated water, harmful matters such as formaldehyde or air which are flowed into the inside of the main body container 6 through the inflow port 10, only gas containing steam is transmitted through the water separator, and then the moisture and harmful matters among the transmitted gas are adsorbed by the water absorption sheet and the harmful matter absorption sheet. Therefore, the gas with less moisture and without harmful matters can be exhausted from the inside of the main body container 6.

The auxiliary device 3 includes a pump 16, a valve 17 and a pressure regulation mechanism 18 as shown in FIG. 1.

The pump 16 is, for example, an air pump which is capable of feeding mixed fluid of gas and liquid and concretely, the pump 16 is a diaphragm pump or a piston pump. In the pump 16, a first inflow port 16a1 is connected to the outlet port 22b of the cathode electrode 22 and a second inflow port 16a2 is connected to the outlet port 21b of the anode electrode 21. An outflow port 16b is connected to the inflow port 10 of the fuel cartridge 2. The pump 16 sucks the generated water or the like which is generated in the cathode electrode 22 and air or the like in the cathode electrode 22, which causes oxygen to be supplied to the cathode electrode 22 from supply port 22a. In addition, the generated water or the like which is generated in the cathode electrode 22 is collected to the collection tank 8 and the internal pressure in the main body container 6 is increased. Further, carbon dioxide or the like generated in the anode electrode 21 is sucked by pump 16.

When a 64 wt. % methanol aqueous solution of 100 g is tentatively consumed in ten hours in the fuel cell system 1, the consumption of the methanol aqueous solution per one minute is 0.167 g, which corresponds to 0.0033 mols of methanol when converted into the molecular weight. In the chemical reaction at the cathode electrode 22, since the oxygen molecule of 1.5 is required with respect to the methanol molecule of 1 and thus 0.005 mols of oxygen is required. In other words, Oxygen of 0.112 L is required. Since oxygen in the air is about 20%, air of 0.56 L/min is required to be supplied to the cathode electrode 22. Actually, all of the oxygen in the air is not always utilized and thus the pump 16 is preferably provided with pump performance having a larger amount of air supply, for example, 1 L/min.

The valve 17 is a valve whose opening and closing operations can be controlled. The inflow port 17a of the valve 17 is connected to the outflow port 11 of the fuel cartridge 2 and the outflow port 17b is connected to the supply port 21a of the anode electrode 21. In other words, the bag shaped container 7 is connected to the anode electrode 21 through the valve 17. Various actuators such as a solenoid or a motor can be used as the opening/closing actuator for the valve 17.

The pressure regulation mechanism 18 adjusts and maintains the differential pressure between the internal pressure of the main body container 6 and the pressure of the outlet port 21b of the anode electrode 21 or the differential pressure between the internal pressure of the main body container 6 and an external-pressure (atmospheric pressure) at a predetermined pressure. The pressure regulation mechanism 18 is connected to the exhaust port 12 of the fuel cartridge 2. The pressure regulation mechanism 18 in an embodiment of the present invention is structured such that the differential pressure between the internal pressure of the main body container 6 and the pressure of the outlet port 21b of the anode electrode 21 is adjusted and maintained at a predetermined pressure. However, when the differential pressure between the internal pressure of the main body container 6 and the external pressure is adjusted and maintained at a predetermined pressure, the differential pressure between the internal pressure of the main body container 6 and the pressure of the outlet port 21b of the anode electrode 21 can be approximately adjusted and maintained at a predetermined pressure.

The pressure regulation mechanism 18 is, for example, a pressure regulating valve provided with a discharge port in which, when the differential pressure becomes greater than the predetermined pressure, its valve is to be in an open state and gas is discharged. A valve may be used as the pressure regulating valve, which is provided with a pressure sensor and an opening/closing actuator for performing the opening/closing of the valve and structured to perform the opening and closing of the valve based on a detected result of the pressure sensor. Alternatively, a pressure regulating valve may be used in which a valve is urged in a closed state with a spring and, when the differential pressure becomes equal to the predetermined pressure, the valve is set to be in an open state against the urging force of the spring and the discharge of gas is performed. Further, the pressure regulation mechanism 18 is not limited to the pressure regulating valve. For example, the pressure regulation mechanism 18 may be provided with a pressure sensor and structured such that the output adjustment of the pump 16 is performed based on the detected result of the pressure sensor.

Operations of the fuel cell system 1 structured as described above will be described below.

On the occasion of starting the operation of the fuel cell system 1, firstly the valve 17 is set to be in a closed state and the pump 16 is sufficiently operated and, as a result, the internal pressure of the main body container 6 is increased. When the internal pressure of the main body container 6 is increased, the differential pressure between the internal pressure of the main body container 6 and the pressure of the outlet port 21b of the anode electrode 21 or the differential pressure between the internal pressure of the main body container 6 and the external pressure (atmospheric pressure) is maintained at the predetermined pressure by the operation of the pressure regulation mechanism 18. For example, the differential pressure is maintained at a predetermined pressure of about 10-20 kPa. More concretely, the differential pressure is maintained at a pressure of about 10 kPa. The maintained differential pressure is not limited to the above-mentioned value and may be set at a larger value or a smaller value.

In this state, since the pressure of 10 kPa, for example, is applied on the surface of the bag shaped container 7, when the valve 17 is set to be in an open state, the methanol aqueous solution is supplied to the anode electrode 21 from the bag shaped container 7 through the valve 17. Further, in this state, when the valve 17 is set to be in a closed state, the supplying of the methanol aqueous solution is stopped.

The flow rate per unit time of the methanol aqueous solution passing through the valve 17, in other words, the supply amount of the methanol aqueous solution to the anode electrode 21 is determined by the differential pressure between the internal pressure of the main body container 6 and the pressure of the outlet port 21b of the anode electrode 21. Therefore, the differential pressure between the internal pressure of the main body container 6 and the pressure of the outlet port 21b of the anode electrode 21 is maintained constant by the pressure regulation mechanism 18 and, as a result, the supply amount of the methanol aqueous solution can be controlled. Alternatively, when a pressure regulating valve, which is provided with a pressure sensor and an opening/closing actuator for performing the opening and closing of the valve, is used as the pressure regulation mechanism 18, the differential pressure between the internal pressure of the main body container 6 and the pressure of the outlet port 21b of the anode electrode 21 can be variably adjusted by the pressure sensor and the opening/closing actuator, or the differential pressure between the internal pressure of the main body container 6 and the external-pressure can be also variably adjusted. As a result, the supply amount of the methanol aqueous solution can be controlled in a variable manner.

In the anode electrode 21 to which the methanol aqueous solution is supplied, the chemical reaction described in the above-mentioned equation (1) occurs and the methanol aqueous solution dissociates into hydrogen ions, electrons and carbon dioxide. The hydrogen ions transmit through the electrolyte membrane 23 and move to the cathode electrode 22, and the electrons move to the cathode electrode 22 through an electric circuit. Further, the carbon dioxide or the like which is generated in the anode electrode 21 is sucked by the pump 16 and discharged from the outlet port 21b. The second inflow port 16a2 of the pump 16 is connected to the outlet port 21b. Therefore, when the pump 16 is operated, a negative pressure is generated near the outlet port 21b, and thus the methanol aqueous solution can be efficiently supplied to the anode electrode 21 when the valve 17 is opened.

Fresh air flows into the cathode electrode 22 from the supply port 22a by the sucking force of the pump 16. In other words, while the pump 16 is operated, oxygen required for the chemical reaction described in the above-mentioned equation (2) is continuously supplied from the supply port 22a to the cathode electrode 22. Further, hydrogen ions are transmitted through the electrolyte membrane 23 and supplied to the cathode electrode 22, and electrons are supplied to the cathode electrode 22 through the electric circuit. Accordingly, the chemical reaction described in the above-mentioned equation (2) occurs and water is generated. The generated water is sucked by the pump 16 together with air or the like in the cathode electrode 22 and discharged from the outlet port 22b.

The carbon dioxide or the like discharged from the outlet port 21b of the anode electrode 21 or the generated water, air or the like discharged from the outlet port 22b of the cathode electrode 22 is collected to the collection tank 8 by the pump 16. Harmful matters such as formic acid, formaldehyde or carbon monoxide may be discharged from the outlet port 21b of the anode electrode 21 or the outlet port 22b of the cathode electrode 22. These harmful matters are collected to the collection tank 8 by the pump 16.

When the pump 16 is operated, the pressure of the collection tank 8, in other words, the internal pressure of the main body container 6 is gradually increased. After that, when the differential pressure between the internal pressure of the main body container 6 and the pressure of the outlet port 21b of the anode electrode 21 becomes greater than a predetermined pressure, alternatively when the differential pressure between the internal pressure of the main body container 6 and the external-pressure becomes greater than a predetermined pressure, the pressure regulation mechanism 18 is operated and the gas in the inside of the main body container 6 is discharged from the discharge port of the pressure regulation mechanism 18 through the filter 9 and the exhaust port 12. At this time, only gas containing steam is transmitted through the water separator which constructs the filter 9, moisture and harmful matters among the transmitted gas are adsorbed by the water absorption sheet and the harmful matter absorption sheet, and thus the gas with less moisture and without harmful matters is exhausted from the inside of the main body container 6.

As described above, the fuel cartridge 2 in accordance with an embodiment of the present invention is structured in a double structure which is provided with a main body container 6 formed of rigid body and a flexible bag shaped container 7 as a fuel tank which is disposed in the inside of the main body container 6. Further, the portion structured by the inner side of the main body container 6 and the outer side of the bag shaped container 7 is formed as the collection tank 8 for collecting products generated in the power generating device 4. In other words, the space of the inside of the main body container 6 which is generated due to the reduction of the methanol aqueous solution is capable of being utilized as the collection tank 8 for collecting products, e.g., principally the generated water which is generated in the cathode electrode 22. Therefore, the collection tank is not required to be provided separately and the volume efficiency of the fuel cell system 1 can be improved. As described above, the collecting capability for the generated water by using the collection tank 8 is sufficient and thus the fuel cell system 1 is provided with a sufficient disposal function of the generated water which is generated in the cathode electrode 22.

The methanol aqueous solution is stored in the bag shaped container 7 as fuel. Gas such as air or the like is intermingled into the bag shaped container 7 only in a negligible extent and the bag shaped container 7 has a flexible property. Therefore, when pressure is applied to the bag shaped container 7 from the outside, the methanol aqueous solution can be supplied from the fuel cartridge 2 regardless of the attitude of the fuel cartridge 2.

In addition, since the main body container 6 is formed of a rigid body, the bag shaped container 7 which is a fuel tank is not damaged by a force from the outside of the fuel cartridge 2 even though the bag shaped container 7 disposed within the main body container 6 is formed of a flexible member. Therefore, the methanol aqueous solution which is a flammable liquid can be safely handled.

Further, the collection tank 8 is formed in the inside of the main body container 6 of the fuel cartridge 2. Therefore, the collection tank 8 is automatically changed when the fuel cartridge 2 is exchanged after the methanol aqueous solution has been used up. Accordingly, the maintenance operation which is dedicated to the collection tank is unnecessary and thus maintenance operation of the fuel cell system 1 becomes easy.

In an embodiment of the present invention, the filter 9 is disposed in the inside of the main body container 6. The filter 9 is provided with the harmful matter absorption sheet for adsorbing harmful matters, the water absorption sheet and the water separator. Therefore, harmful matters such as formaldehyde, formic acid or carbon monoxide can be adsorbed in the harmful matter absorption sheet, and thus the harmful matters are not discharged even when the exhaust gas collected from the power generating device 4 is discharged from the collection tank 8 to the outside. Accordingly, the clean fuel cell system 1 can be obtained. In addition, since the steam transmitted through the water separator is adsorbed by the water absorption sheet, the possibility is remarkably reduced that dew condensation and mildew are generated in the vicinity of the discharge port of the exhaust-gas.

Further, in the fuel cell system 1 in accordance with an embodiment of the present invention, the first inflow port 16a1 of the pump 16 is connected to the cathode electrode 22 and the pump 16 supplies oxygen to the cathode electrode 22 from the supply port 22a by means of that the pump 16 sucks the generated water which is generated in the cathode electrode 22 and air in the cathode electrode 22. Also, the outflow port 16b of the pump 16 is connected to the collection tank 8 to collect the generated water in the collection tank 8 and increase the internal pressure of the main body container 6. Therefore, a pressure can be applied by operating the pump 16 to the bag shaped container 7 as a fuel tank, which is disposed by the inside of main body container 6, and thus the methanol aqueous solution can be supplied to the anode electrode 21. In other words, the only one pump 16 is provided with the collecting function of the generated water which is generated in cathode electrode 22, the supplying function of oxygen to the cathode electrode 22, and the supplying function of the methanol aqueous solution to the anode electrode 21. Accordingly, the downsizing of the fuel cell system 1 can be attained and its volume efficiency can be improved. Also, since only one pump is required, the electric power consumed by the auxiliary device 3 can be reduced and, as a result, the efficiency of power generation can be improved. In addition, the methanol aqueous solution is supplied to the anode electrode 21 by applying a pressure to the bag shaped container 7 from the outside and thus the methanol aqueous solution can be supplied to the anode electrode 21 even though the fuel cell system 1 is set to be in any attitude.

Further, since the outflow port 16b of the pump 16 is connected to the collection tank 8, the collection tank 8 is capable of serving as the role of the muffler of the pump 16 which is an air pump. Therefore, the operation noise of the pump 16 can be reduced and thus the quiet fuel cell system 1 can be provided.

In an embodiment of the present invention, the bag shaped container 7 is connected to the anode electrode 21 through the valve 17 whose opening and closing can be controlled. Therefore, when the valve 17 is closed, the outflow of the methanol aqueous solution from bag shaped container 7 is prevented and, only when the power generation is required, the methanol aqueous solution can be supplied to the anode electrode 21, and thus power generation efficiency can be improved. Further, for example, even when the fuel cell system 1 is used in a portable device, the possibility becomes remarkably low that the methanol aqueous solution flows out to the anode electrode 21 due to vibrations and impacts at the time of carrying the portable device and thus the methanol aqueous solution can be effectively utilized.

In an embodiment of the present invention, the auxiliary device 3 is provided with the pressure regulation mechanism 18 by which the differential pressure between the internal pressure of the main body container 6 and the pressure of the outlet port 21b of the anode electrode 21 is adjusted and maintained at a predetermined pressure, or the differential pressure between the internal pressure of the main body container 6 and the external-pressure is adjusted and maintained at a predetermined pressure. Therefore, the differential pressure between the internal pressure of the main body container 6 and the pressure of the outlet port 21b of the anode electrode 21 can be maintained at the predetermined pressure. Further, the supply amount of the methanol aqueous solution which is supplied to the anode electrode 21 can be controlled by the opening and closing of the valve 17.

The differential pressure between the internal pressure of the main body container 6 and the pressure of the outlet port 21b of the anode electrode 21 is maintained at the predetermined pressure by the pressure regulation mechanism 18. Therefore, even though the environment where atmospheric pressure is low such as at a high altitude or in an aircraft, the supply condition of the methanol aqueous solution is maintained to be constant and the supply of the methanol aqueous solution can be stably controlled.

In an embodiment of the present invention, the second inflow port 16a2 of the pump 16 is connected to the anode electrode 21. Therefore, carbon dioxide or the like generated in the anode electrode 21 can be sucked by the pump 16 and a negative pressure is generated in the anode electrode 21, and thus the methanol aqueous solution can be efficiently supplied to the anode electrode 21 when the valve 17 is opened. Accordingly, the flow passage formed in the anode electrode 21 can be made smaller in a detailed manner and, as a result, the power generation efficiency can be improved.

Although the present invention has been shown and described with reference to specific embodiments, various changes and modifications will be apparent to those skilled in the art from the teachings herein.

For example, in the case that the power generating device 4 is provided with a plurality of power generating parts, a plurality of valves 17 may be provided so as to correspond to the plurality of anode electrodes 21. According to the construction described above, the methanol aqueous solution can be selected to be discharged to one of the plurality of anode electrodes 21 and thus the discharge destination of the methanol aqueous solution can be controlled. In addition, even in the case that clogging occurs at the supply passage of the methanol aqueous solution to one of the anode electrodes 21, the methanol aqueous solution can be discharged to the supply passage where the clogging has occurred. Therefore, the clogging may be eliminated and the supply of the methanol aqueous solution can be performed.

Further, when the power generating device 4 is provided with a plurality of power generating parts, the outlet ports 22b of the cathode electrodes 22 may be coupled and formed into one passage to connect to the first inflow port 16a1 of the pump 16. Alternatively, the outlet ports 22b of the cathode electrodes 22 may be connected to the first inflow port 16a1 of the pump 16 through a plurality of valves which are respectively provided corresponding to the plurality of cathode electrodes 22, and generated water or the like generated in the cathode electrodes 22 may be successively sucked. In the latter case, even when clogging occurs in the discharge flow passage between one of the cathode electrodes 22 and the pump 16, the generated water or the like can be sucked from the discharge flow passage where the clogging has occurred, and thus the clogging may be eliminated and the discharge of the generated water or the like can be performed.

In addition, the pump 16 is not always required to provide the methanol aqueous solution supply function to the anode electrode 21. Alternatively, a liquid pump may be provided between the bag shaped container 7 and the valve 17, and the methanol aqueous solution is supplied by the liquid pump. When a displacement type of pump is used as a liquid pump, the supply amount of the methanol aqueous solution can be controlled by the operation number of revolutions of the liquid pump.

In addition, the pump 16 is not always required to provide the supplying function of oxygen to the cathode electrode 22. An air pump for supplying oxygen may be separately provided to supply air to the supply port 22a of the cathode electrode 22. Further, in the case that the collection of the generated water generated in the cathode electrode 22 is not always required, the pump 16 is not required to provide the collecting function of the generated water.

Further, when high concentration methanol is stored in the bag shaped container 7, the generated water which is collected can be used for dilution by utilizing the structure described below. In other words, the auxiliary device 3 is further provided with a mixing vessel for mixing the generated water which is generated in the cathode electrode 22 and the high concentration methanol, a flow passage for guiding the generated water collected in the collection tank 8 to the mixing vessel, and a second valve, and the inflow port of the mixing vessel is connected to the second valve and the valve 17, and the outflow port of the mixing vessel is connected to the anode electrode 21. According to the construction described above, the high concentration methanol can be stored in the bag shaped container 7 as a fuel tank, and thus the volume efficiency of the fuel cell system 1 can be further improved.

Moreover, an RFID (Radio Frequency IDentification) tag may be provided on the fuel cartridge 2 and a memory may be provided in which data such as concentration and remaining capacity of the methanol aqueous solution are rewritable.

Further, the pressure regulation mechanism 18 is not required to be provided in the auxiliary device 3 and may be provided in the fuel cartridge 2. When the differential pressure between the internal pressure of the main body container 6 and the pressure of the outlet port 21b of the anode electrode 21 can be maintained at the predetermined pressure due to the compression capability of the pump 16 and the loss in the filter 9, the pressure regulation mechanism 18 may not be provided.

Further, the pressure regulation mechanism 18 may not be provided when the supply amount of the methanol aqueous solution is controlled by means of that the differential pressure between the internal pressure of the main body container 6 and the pressure of the outlet port 21b of the anode electrode 21 is detected to control the opening and closing time period of the valve 17. Alternatively, the pressure regulation mechanism 18 may not be provided when a flow sensor is provided between the bag shaped container 7 and the cathode electrode 21 to control the supply amount of the methanol aqueous solution based on the flow sensor. In this case, when the exhaust gas collected by the pump 16 from the power generating device 4 is required to discharge outside, an exhaust valve may be provided at the position of the pressure regulation mechanism 18.

Moreover, the water absorption sheet provided in the filter 9 may use a sheet having a water absorbing property and is not always required to use high polymer resin having a water absorbing property. Further, when steam is permitted to be discharged from the exhaust port 12, the filter 9 is not always required to be provided with the water absorption sheet.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A fuel cartridge which stores fuel to be supplied to a power generating device of a fuel cell system comprising:
a main body container formed of a rigid body;
a bag shaped container, into which the fuel is to be stored, having a flexible property which is disposed inside of the main body container such that the main body container and the bag shaped container are constructed in a double structure; and
a collection tank which is formed by a space between an inner side of the main body container and an outer side of the bag shaped container for collecting a product generated in the power generating device.

2. The fuel cartridge according to claim 1, further comprising a filter which is disposed in the inside of the main body container for adsorbing at least a part of the product.

3. A fuel cell system comprising:
a fuel cartridge recited in claim 1;
a power generating device including a power generating part; and
a pump disposed between the fuel cartridge and the power generating device;
wherein an inflow port of the pump is connected to a cathode electrode constructing the power generating part, whereby the suction of the pump supplies oxygen to the cathode electrode and collects air and water to the collection tank, the water being generated in the cathode electrode, and an outflow port of the pump is connected to the collection tank.

4. The fuel cell system according to claim 3, wherein the fuel cartridge includes a filter which is disposed in the inside of the main body container for adsorbing at least a part of the product.

5. The fuel cell system according to claim 3, wherein an internal pressure of the main body container is increased by the pump.

6. The fuel cell system according to claim 3, further comprising a valve whose opening and closing are controllable through which the bag shaped container is connected to an anode electrode constructing the power generating part.

7. The fuel cell system according to claim 6, further comprising a pressure regulation mechanism which maintains one of a differential pressure between an internal pressure of the main body container and a pressure of an outlet port of the anode electrode and a differential pressure between the internal pressure of the main body container and an external-pressure of the main body container at a predetermined pressure.

8. The fuel cell system according to claim 6, wherein the power generating device is provided with a plurality of power generating parts and a plurality of valves are provided so as to correspond to a plurality of anode electrodes of the plurality of power generating parts.

9. The fuel cell system according to claim 3, wherein the inflow port of the pump is connected to an anode electrode constructing the power generating part.

10. A fuel cell system comprising:
a fuel cartridge recited in claim 1;
a power generating device including a power generating part; and
a pump disposed between the fuel cartridge and the power generating device;
wherein an inflow port of the pump is connected to a cathode electrode constructing the power generating part, whereby the suction of the pump supplies oxygen to the cathode electrode and collects air and water to the collection tank, the water being generated in the cathode electrode, and an outflow port of the pump is connected to the collection tank and increases the pressure of the main body container.

11. The fuel cell system according to claim 10, wherein the fuel cartridge includes a filter for adsorbing at least a part of the product which is disposed in the inside of the main body container.

12. The fuel cell system according to claim 10, further comprising a valve whose opening and closing are controllable, through which the bag shaped container is connected to an anode electrode constructing the power generating part.

13. The fuel cell system according to claim 12, further comprising a pressure regulation mechanism which maintains one of a differential pressure between the internal pressure of the main body container and a pressure of an outlet port of the anode electrode and a differential pressure between the internal pressure of the main body container and an external-pressure of the main body container at a predetermined pressure.

14. The fuel cell system according to claim 12, wherein the power generating device is provided with a plurality of power generating parts and a plurality of valves are provided so as to correspond to a plurality of anode electrodes of the plurality of power generating parts.

15. The fuel cell system according to claim 10, wherein the inflow port of the pump is connected to an anode electrode constructing the power generating part.

16. A fuel cell system comprising:
a fuel cartridge recited in claim 1;
a power generating device including a power generating part; and
a pump disposed between the fuel cartridge and the power generating device;
wherein an inflow port of the pump is connected to a cathode electrode constructing the power generating part, an outflow port of the pump is connected to the collection tank, and the pump collects generated water which is generated in the cathode electrode to the collection tank and increases an internal pressure of the main body container.

17. The fuel cell system according to claim 16, wherein the fuel cartridge includes a filter for adsorbing at least a part of the product which is disposed in the inside of the main body container.

18. The fuel cell system according to claim 16, further comprising a valve whose opening and closing are controllable, through which the bag shaped container is connected to an anode electrode constructing the power generating part.

19. The fuel cell system according to claim 18, further comprising a pressure regulation mechanism which maintains one of a differential pressure between the internal pressure of the main body container and a pressure of an outlet port of the anode electrode and a differential pressure between the internal pressure of the main body container and an external-pressure of the main body container at a predetermined pressure.

20. The fuel cell system according to claim 18, wherein the power generating device is provided with a plurality of power generating parts and a plurality of valves are provided so as to correspond to a plurality of anode electrodes of the plurality of power generating parts.

21. The fuel cell system according to claim 16, wherein the inflow port of the pump is connected to an anode electrode constructing the power generating part.
